(19) United States
(12) Patent Application Publication
(10) Pub. No.: US 2003/0220794 A1
(43) Pub. Date: Nov. 27, 2003

(54) Speech processing system

(75) Inventor: Chiwei Che, Berkshire (GB)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/441,051

(22) Filed: May 20, 2003

(30) Foreign Application Priority Data
May 27, 2002 (GB) 0212166.3

(51) Int. Cl. G10L 21/00

(52) U.S. Cl. 704/270.1

(57) ABSTRACT

A client-server speech processing system is provided in which the client terminal transmits digitised speech data over a data network to the server terminal. The client terminal varies the way in which the speech signal is digitised in dependence upon, for example, the traffic state of the data network. The remote server receives the digitised speech signal and processes it to generate processed digitised speech data that is independent of the variation of the digitisation process carried out at the client terminal. The processed digitised speech data is then passed to a speech recognition unit in the server terminal which compares the processed digitised speech data with a set of speech recognition models. The remote server is also arranged to vary the set of speech recognition models used by the speech recognition unit in dependence upon the way in which the digitising process was varied by the client terminal.

The present invention relates to a speech processing system. The invention is particularly related to a client-server speech processing system in which speech entered at the client is transmitted over a communication link to a server where it is processed. The processing performed at the server may be, for example, a speech recognition processing or a speaker verification processing or the like.

The performance of traditional client-server based speech recognition systems can degrade significantly when the speech data is transmitted from the client to the server over a data network or a layer of networks such as the Internet. It is currently believed that this degradation is due to the mismatch between the training of the speech recognition system and the subsequent use of the speech recognition system to recognise the input speech. Accordingly, some current techniques try to overcome this problem by training the speech recognition system with speech received over all possible transmission channels in the data network.

However, the inventor has realised that part of the problem with such client-server speech processing systems is that the data network can introduce additional dimensions of variability to the speech data. In particular, the speech data transmitted over the data network is not always the same and depends on the current traffic state within the data network. More specifically, prior to transmitting the speech data over the data network, the client terminal checks the traffic state within the network and varies one or more of: the bit rate, sampling rate or coding format of the transmitted speech data and the remote server terminal reconverts the received speech data back into the appropriate format for use by the speech recognition system at the server. As a result, the speech recognition system operating on the remote server is unaware of the modifications that have been made to the speech data in being transmitted from the client over the data network.

According to one aspect, the present invention provides a client-server speech processing system in which the set of speech recognition models used by the recognition system in the server terminal is dynamically varied depending on the digitisation process carried out by the client terminal.

According to another aspect, the present invention provides a speech processing system comprising: a data network, one or more client terminals and a server terminal and wherein the client terminal operates to digitise a received speech signal and includes means for dynamically varying a digitising parameter of the digitisation process in dependence upon an external condition and wherein the server terminal processes the digitised speech data to generate processed digitised speech data that is independent of the variation of the digitising parameter and includes means for dynamically varying a set of speech recognition models used by a speech recognition means of the server in dependence upon parameter data identifying the dynamic variation of the digitising parameter performed by the client terminal.

The parameter data may be transmitted from the client terminal to the server terminal together with the digitised speech data. Alternatively, the server terminal may determine the parameter data automatically either by, for example, monitoring the external condition itself or by processing the digitised speech data to determine the parameter data.

The system may be used in various applications such as a telephone voicemail retrieval system or an automated dialogue system.

Exemplary embodiments of the present invention will now be described with reference to the following drawings in which:

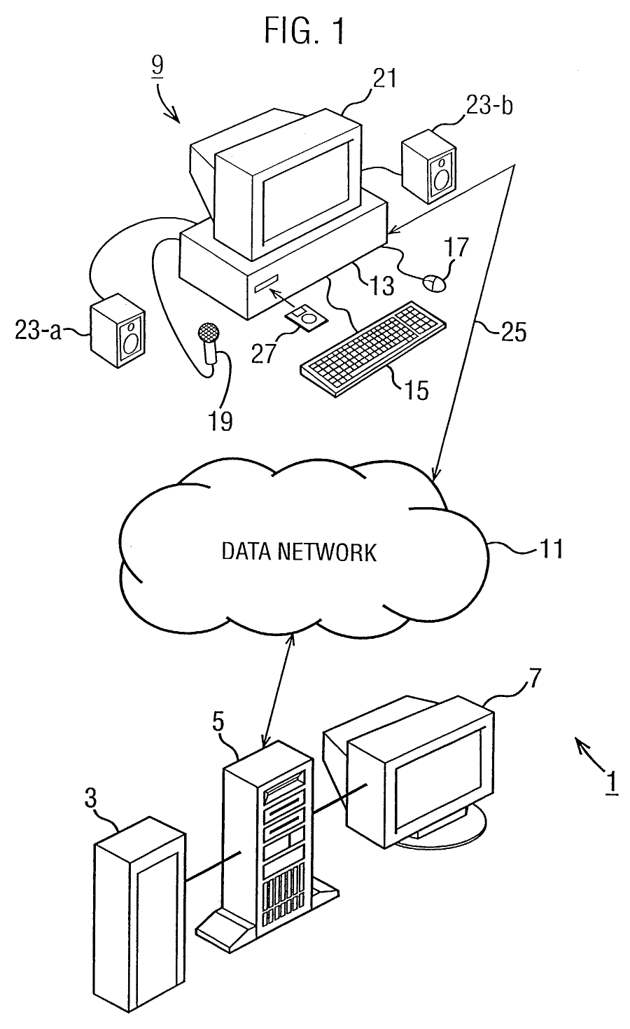

FIG. 1 is a schematic diagram illustrating a client-server speech processing system in which a client terminal communicates with a remote server terminal over a data network;

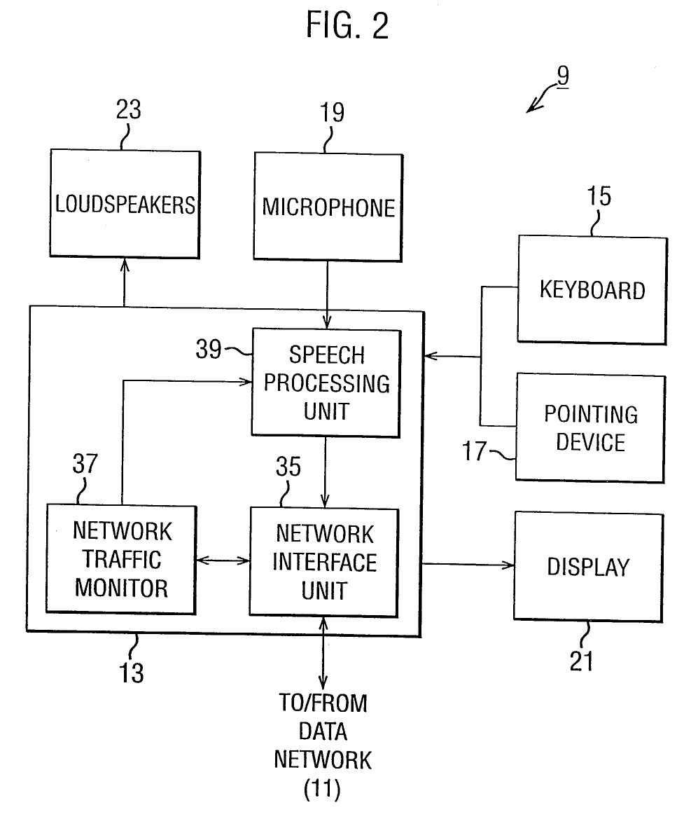

FIG. 2 is a block diagram illustrating the main components of the client terminal shown in FIG. 1;

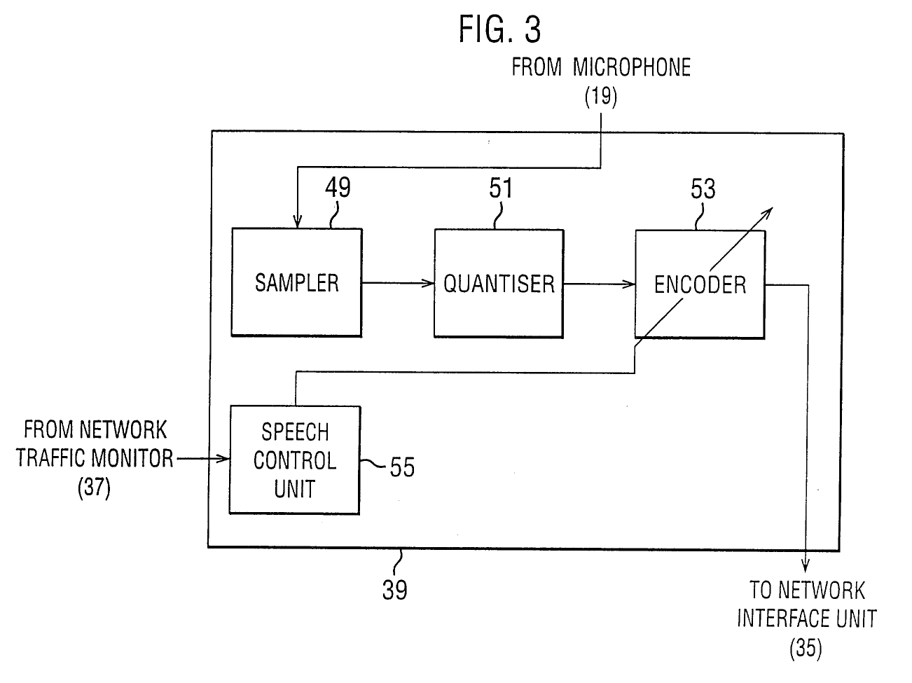

FIG. 3 is a block diagram illustrating the main components of a speech processing unit which forms part of the client terminal shown in FIG. 2;

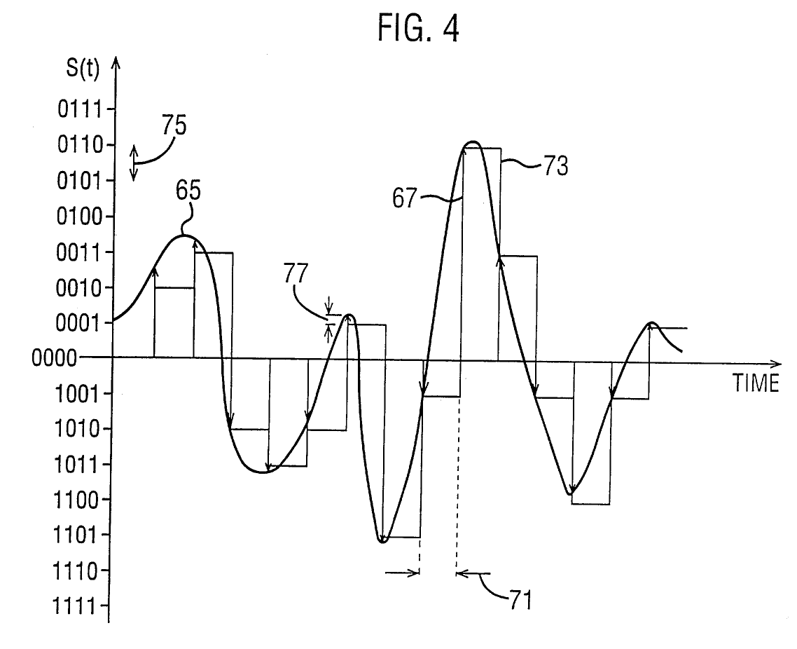

FIG. 4 is a plot illustrating a speech signal, samples taken from the speech signal and the corresponding quantised speech signal levels derived therefrom;

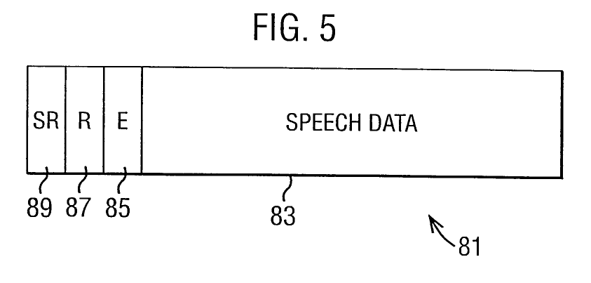

FIG. 5 illustrates the form of part of a data packet transmitted between the client terminal and the server terminal shown in FIG. 1;

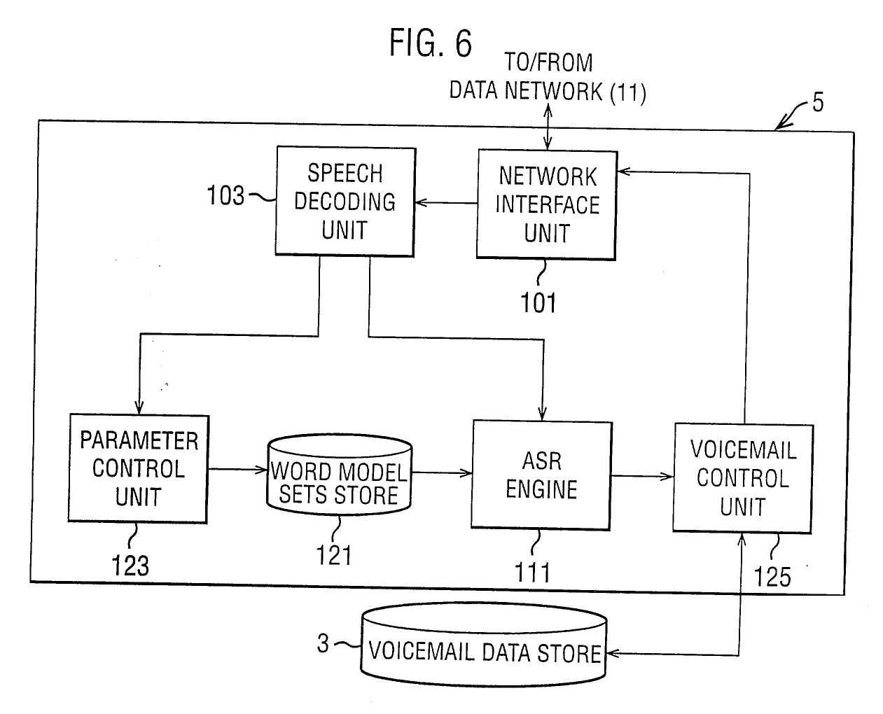

FIG. 6 is a block diagram illustrating the main components of the server terminal shown in FIG. 1;

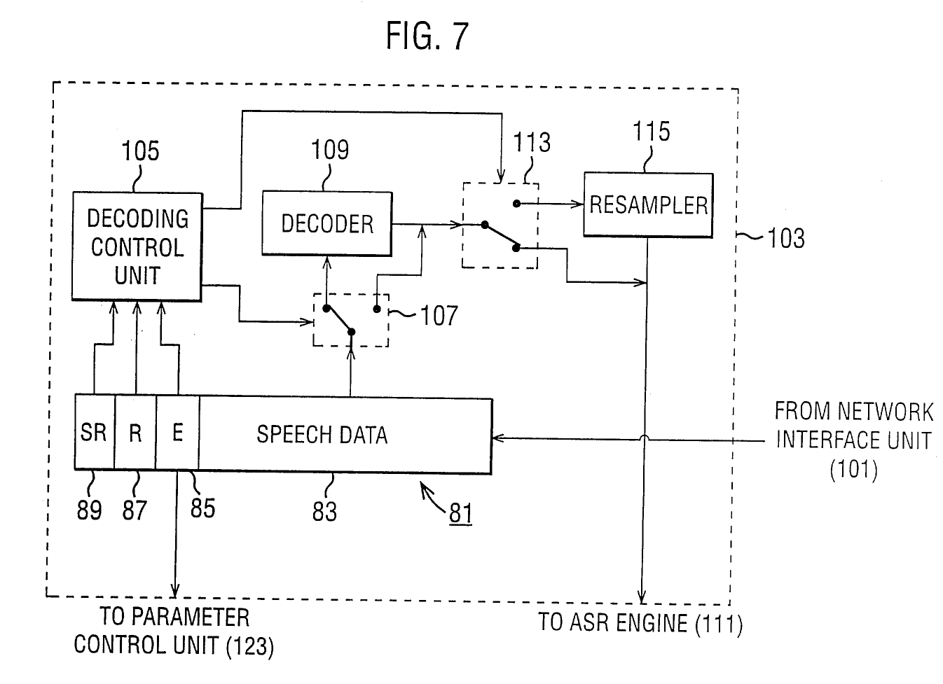

FIG. 7 is a block diagram illustrating the main components of a speech decoding unit forming part of the server terminal shown in FIG. 6;

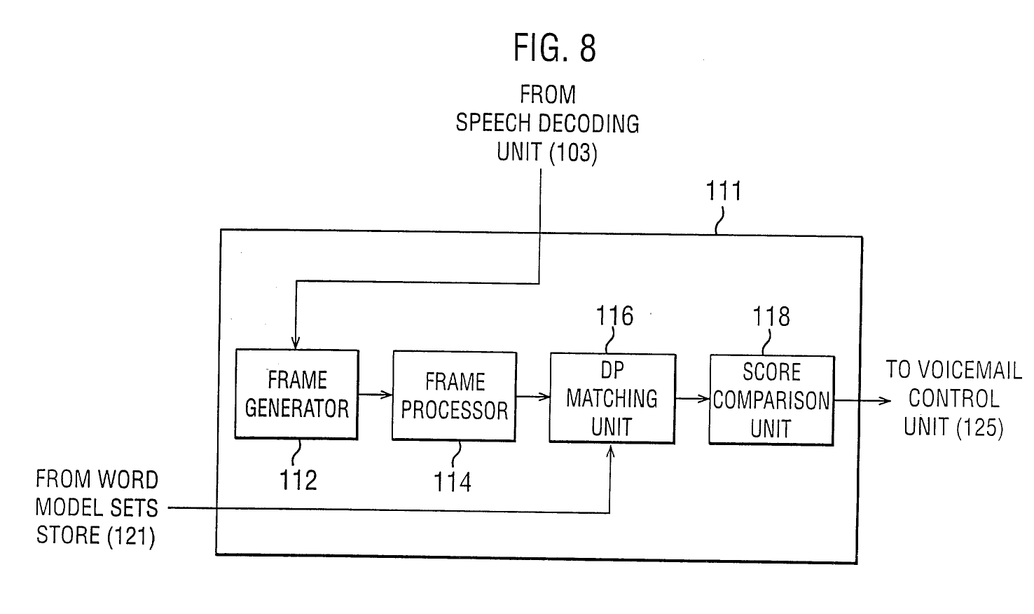

FIG. 8 is a block diagram illustrating the main components of an automatic speech recognition engine forming part of the server terminal shown in FIG. 6;

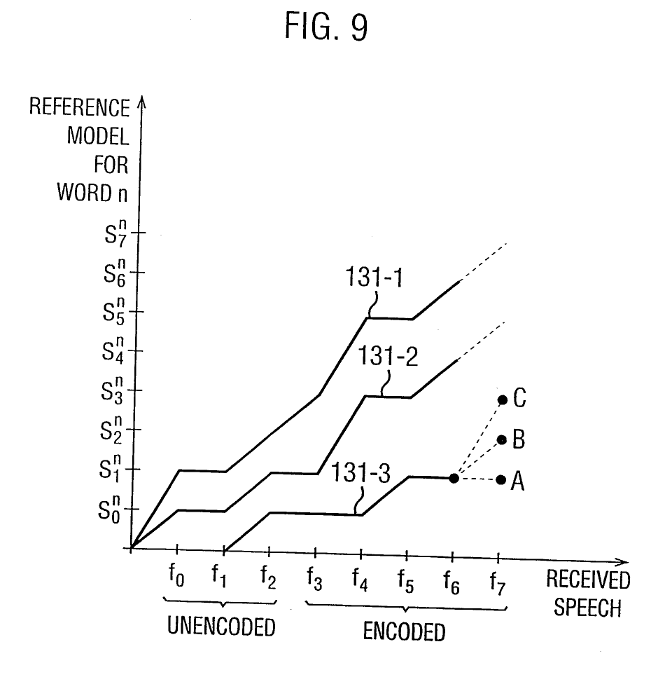

FIG. 9 is a plot illustrating a dynamic programming matching operation for matching a sequence of input frames against a sequence of reference model states;

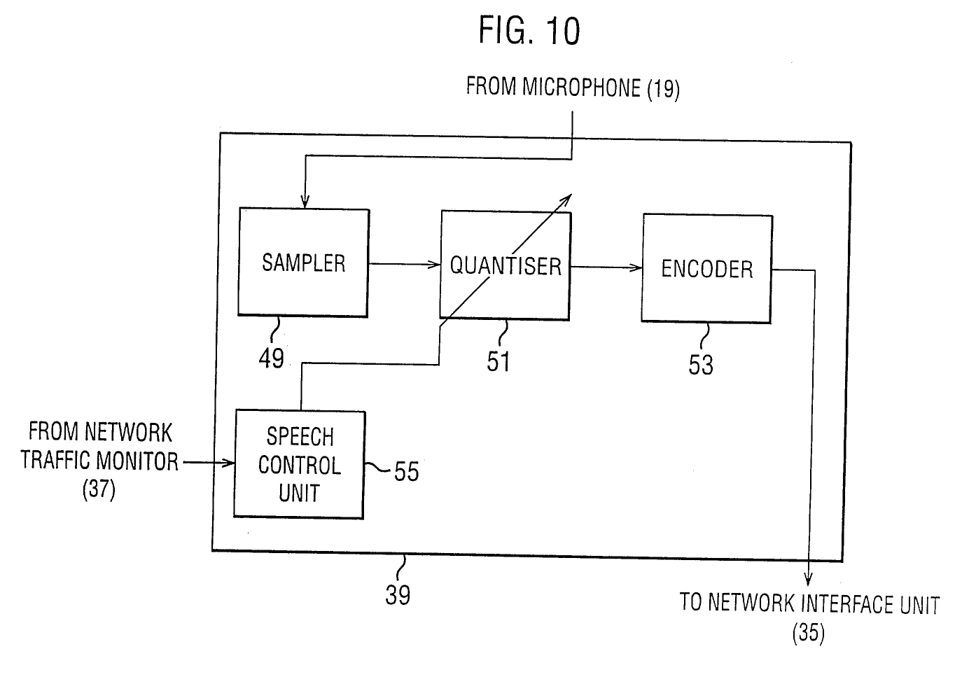

FIG. 10 is a block diagram illustrating the main components of a speech processing unit which forms part of the client terminal shown in FIG. 2 in a second embodiment;

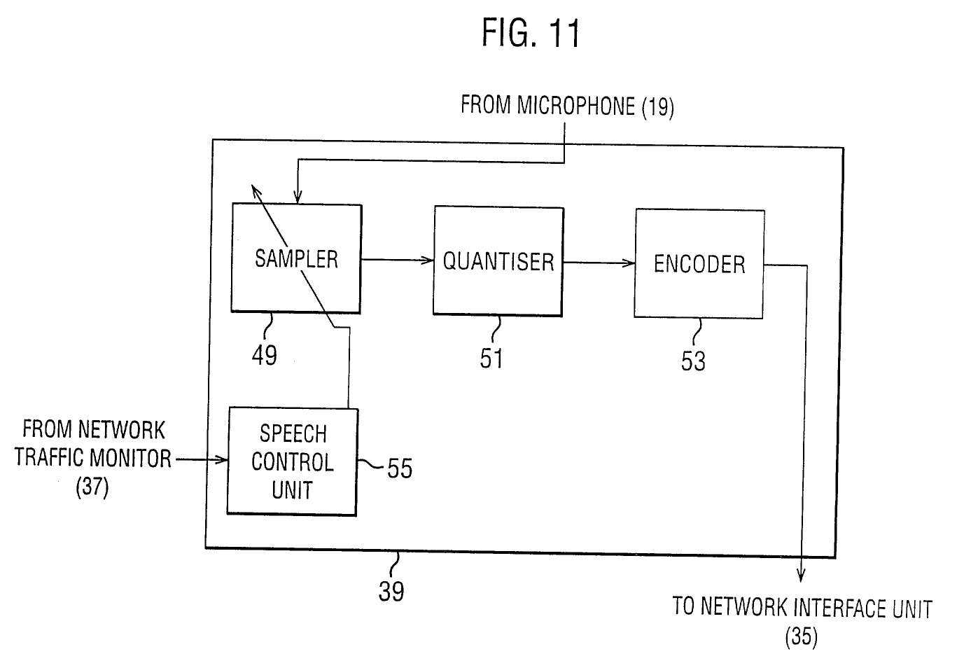

FIG. 11 is a block diagram illustrating the main components of a speech processing unit which forms part of the client terminal shown in FIG. 2 in a third embodiment;

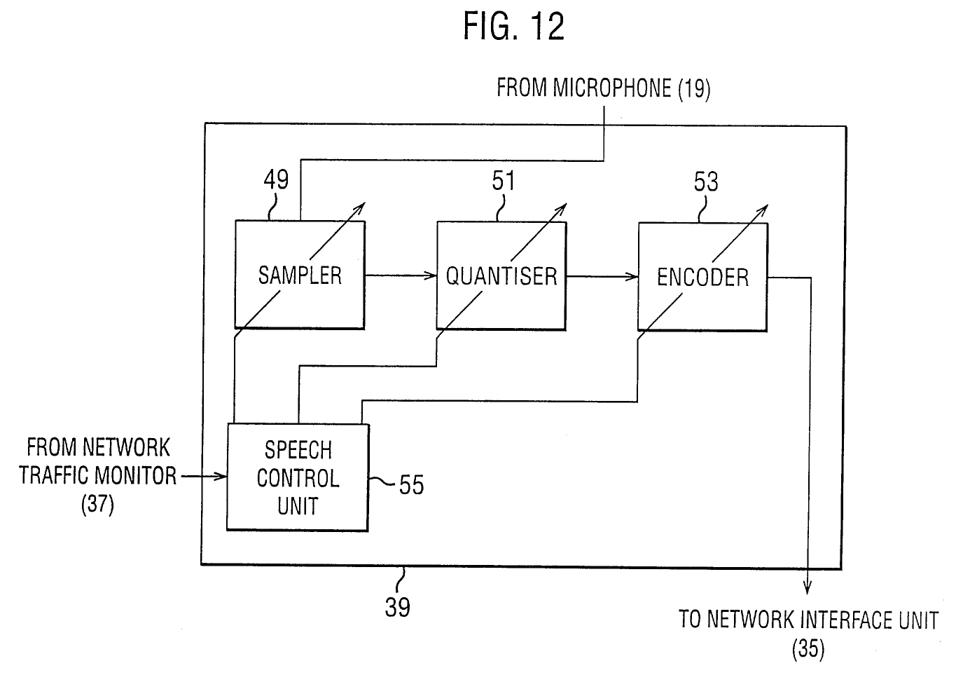

FIG. 12 is a block diagram illustrating the main components of a speech processing unit which forms part of the client terminal shown in FIG. 2 in a fourth embodiment;

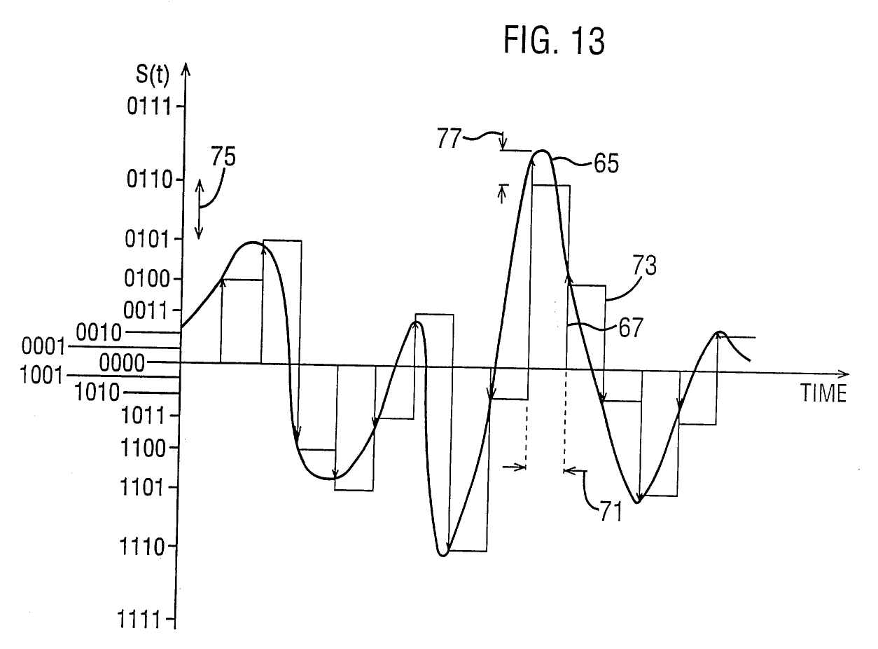

FIG. 13 is a plot illustrating a speech signal, samples taken from the speech signal and the corresponding quantised speech signal levels derived therefrom using a non-linear quantisation technique; and

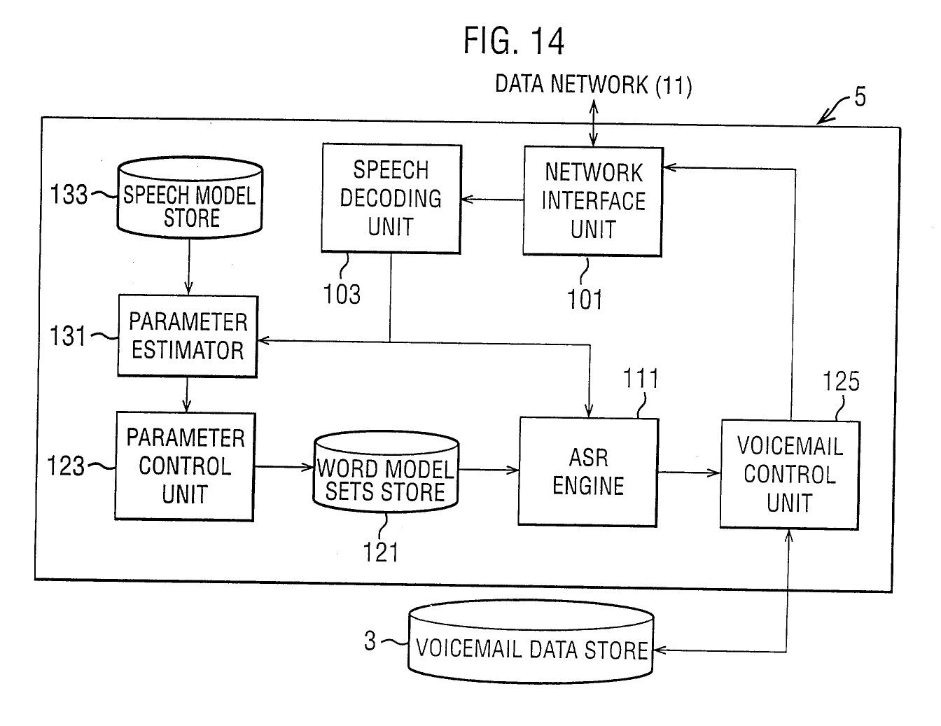

FIG. 14 is a block diagram illustrating the main components of a server terminal which may be used in the system shown in FIG. 1 in a fifth embodiment.

### FIRST EMBODIMENT

Overview

FIG. 1 is a schematic diagram illustrating a client-server voicemail retrieval system 1. The server side of the system 1 includes a voicemail data store 3 for storing voicemails for a plurality of different users and a mail server 5, which controls the storing and retrieval of voicemail messages within the data store 3. The server system also includes a display 7 on which various status messages may be displayed to a supervising controller (not shown). The mail server 5 is connected to a plurality of client terminals 9 (one of which is shown in FIG. 1) via a data network 11. The mail server 5 is operable to control the storage, retrieval and deletion of voicemail messages in the mail data store 3 in response to messages or requests received from client devices 9.

As shown in FIG. 1, the client terminal 9 in this embodiment includes a personal computer (PC) 13 having a keyboard 15, a pointing device 17, a microphone 19, a display 21 and a pair of loudspeakers 23-a and 23-b. The keyboard 15 and the pointing device 17 enable the client terminal 9 to be controlled by a user (not shown). The microphone 19 is operable to convert acoustic speech signals from the user into an equivalent electrical signal which is supplied to the PC 13 for processing. An internal speech receiving circuit (not shown) is arranged to receive the speech signal, to convert it into a digital signal and to encode the signal for transmission over the data network 11 via the communication link 25.

The program instructions which make the PC 13 operate can be supplied either on a floppy disk 27 or the like or they may be downloaded from the data network 11 on the communication link 25.

The voicemail retrieval system shown in FIG. 1 is designed to allow users to leave voicemail messages for other users and to be able to retrieve voicemail messages sent to them by other users. A brief description of the way in which these voicemail messages are stored and subsequently retrieved will now be described.

Initially, if a user of the client terminal 9 wishes to make a voice call to another user, they make a request through the data network 11 to the voicemail server 1. In this embodiment, the voicemail server 1 checks to see if the other user is currently connected to the data network 11. If they are then the voicemail server 1 initiates a virtual call between the two users through the data network 11. In this case, there is no need for the user of the client terminal 9 to leave a message for the other user. If, however, the other user is not currently connected to the data network 11, then the voicemail server 1 will not be able to establish the call. In response, therefore, the voicemail server 1 transmits an appropriate message back to the client terminal 9 through the data network 11 advising the user that the other user is not available and prompting the user to leave a message for the other user in the voicemail data store 3. The prompt may be transmitted as a text message for display on the display 21 or as speech to be played out through the loudspeakers 23. If the user leaves a message, then the user's speech is encoded and transmitted over the data network 11 to the mail server 5 which stores the message in the voicemail data store 3. In this embodiment, each message is stored together with data identifying the user who left the message, the time that the message was left and the user who is to receive the message.

In addition to being able to leave messages for other users, the user of the client terminal 9 can also retrieve messages that have been left for him by other users. If there are a number of messages for a user stored in the voicemail data store 3, then when that user logs on to the mail server 5, the mail server 5 transmits a message to the client terminal 9 over the data network 11 identifying: (i) any new messages that have been left since the last time the user logged on to the mail server 5; (ii) who the new messages are from; and (iii) old messages that are still stored within the voicemail data store 3. In this embodiment, the mail server 5 transmits this information as text for display on the display 21. In response, the user can either enter a spoken command via the microphone 19 or the user can select a message to be played using the keyboard 15 and/or the pointing device 17.

In the case of a voice command, the client terminal 9 receives the speech signal from the microphone 19 and encodes it depending on the current traffic state of the data network 11. In particular, in this embodiment the client terminal 9 checks the current traffic state within the data network 11 and controls the encoding technique used to encode the received speech signal for transmission to the mail server 5. In this embodiment, if the data network 11 has a low traffic state (i.e. it is not busy) then the client terminal 9 chooses a loss-less encoding technique in which the speech samples of the received speech signal are encoded without loss of information content and transmitted within a sequence of IP (Internet Protocol) data packets through the data network 11 to the mail server 5. If the data network 11 has a high traffic state (i.e. it is busy) then the client terminal 9 chooses a lossy encoding technique in which the speech samples of the received speech signal are encoded in such a manner that some information is lost and then the encoded speech is transmitted within a sequence of IP data packets through the data network 11 to the mail server 5.

In this embodiment, the client terminal 9 also transmits, in each data packet, data identifying how the speech has been encoded so that the mail server 5 can decode the data within the transmitted packets to recover the speech command. The recovered speech command is then passed to an automatic speech recognition unit (not shown) within the mail server 5. In this embodiment, the automatic speech recognition unit has two sets of word models (for the same reference words) against which it can compare the received speech command. One set is generated from training speech data encoded using the lossy encoding technique and the other set is generated from training speech data encoded using the loss-less encoding technique. When the mail server 5 receives the speech command, it uses the received information identifying how the speech was encoded to select the appropriate set of word models to be used in recognising the received speech command. In this embodiment, the speech command may relate to a request for establishing a voice call to another user, a request to retrieve a message from the voicemail data store 3 or a request to delete a message from the voicemail data store 3.

An overview has been given above of the way in which the voicemail system shown in FIG. 1 operates. A more detailed description of this embodiment will now be given with reference to FIGS. 2 to 5.

Client Terminal

FIG. 2 is a block diagram showing in more detail the main components of the client terminal 9 shown in FIG. 1. The same reference numerals have been used to identify the same components shown in FIG. 1 and will not be described again. As shown in FIG. 2, the personal computer 13 includes a network interface unit 35 for interfacing the personal computer 13 to the data network 11. The personal computer 13 also includes a network traffic monitor 37 which is operable to monitor the traffic state within the data network 11 via the network interface unit 35. The way in which the network traffic monitor 37 monitors the traffic is conventional and will not be described further. The current traffic state determined by the network traffic monitor 37 is then output to a speech processing unit 39 which also receives the electrical speech signal from the microphone 19 and encodes it using an encoding technique which depends upon the traffic state determined by the network traffic monitor 37.

FIG. 3 is a block diagram showing in more detail the main components of the speech processing unit 39 used in this embodiment. As shown, the electrical speech signal from the microphone 19 is input to a sampler 49 which operates to sample the received signal at a constant sampling rate (in this embodiment 16 kHz). The speech samples output from the sampler 49 are then input to a quantiser 51 which operates to quantise each of the speech samples into a corresponding binary value. In this embodiment, the quantiser 51 is operable to quantise each speech sample into a sixteen-bit binary value. The sampling and quantisation operation performed by the sampler 49 and the quantiser 51 is illustrated in the plot shown in FIG. 4 (except showing only four-bit quantisation for clarity). In particular, FIG. 4 shows part of a speech signal 65 received from the microphone 19. FIG. 4 also shows the speech samples 67 generated by the sampler 49 at a constant sampling period 71. FIG. 4 also shows the sequence of four-bit binary values 73 generated for the speech samples 67. In this embodiment, the quantiser 51 performs a linear quantisation of the speech samples so that there is a constant quantisation spacing 75 between the quantisation levels. As those skilled in the art will appreciate, the number of bits representing each sample and the dynamic range of variation of the input speech signal defines the resolution of the digitised speech sample output by the quantiser 51. The more bits available to represent each speech sample 67, the higher the resolution of the digital speech samples and the lower the maximum quantisation error 77.

As shown in FIG. 3, the binary speech values output by the quantiser 51 are then input to an encoder 53 which either outputs the binary values unchanged or which encodes the bits using a lossy encoding technique such as the standard speech coding technique ITU-G.723.1. This is a CELP type encoding technique which divides the input speech signal into frames of speech and then determines a set of model parameters that best represents the speech within each frame. The system then transmits the model parameters which are then used to regenerate the speech samples by an appropriate decoder at the receiving terminal.

In this embodiment, the determination of whether or not the encoder 53 performs the encoding is controlled by a speech control unit 55 on the basis of the current traffic state in the data network 11, which is determined by the network traffic monitor 37. In particular, if the network traffic monitor 37 determines that there is a low traffic state within the data network 11, then the speech control unit 55 switches off the encoding performed by the encoder 53, so that the speech data output by the quantiser 51 is passed unencoded to the network interface unit 35. In contrast, if the network traffic monitor 37 determines that there is a high traffic state in the data network 11, then the speech control unit 55 causes the encoder 53 to perform the CELP encoding on the speech data output from the quantiser 51 and the CELP encoded speech data is then passed to the network interface unit 35 for onward transmission to the remote server 5.

The speech data received by the network interface unit 35 from the speech processing unit 39 is packetised into IP data packets which are then transmitted to the remote server 5 via the data network 11. FIG. 5 illustrates part of an IP data packet 81 generated by the network interface unit 35. As shown, the IP data packet 81 includes the encoded or unencoded speech data 83 together with: encoding control data 85 identifying whether or not the speech data 83 is encoded; resolution control data 87 identifying the number of bits used to represent each speech sample by the quantiser 51; and sample rate control data 89 identifying the sampling rate used by the sampler 49 to sample the received speech signal. As those skilled in the art will appreciate, the IP data packet 81 will also include appropriate source and destination addresses and other network control data (not shown).

Server Terminal

FIG. 6 is a block diagram showing in more detail the main components of the server terminal 5 and the voicemail store 3. As shown, the remote server 5 includes a network interface unit 101 which receives the IP data packets 81 transmitted from the client terminal 9. The network interface unit 101 then passes the received IP data packets 81 to a speech decoding unit 103 which is shown in more detail in FIG. 7.

As shown in FIG. 7, the speech decoding unit includes a decoding control unit 105 which takes in the encoding control data 85 from each received IP data packet to determine whether or not the speech data 83 is encoded. If it is encoded, then the decoding control unit 105 outputs a control signal to a switch 107 to cause the speech data 83 to be passed to a decoder 109 which decodes the speech data 83. The decoding control unit 105 also reads the resolution control data 87 and the sampling rate control data 89 of the received IP data packet 81, to determine if the resolution and sampling rate of the received speech data conforms to that required by an automatic speech recognition (ASR) engine 111 (shown in FIG. 6) which will be used to recognise the received speech. In this embodiment, the ASR engine 111 is designed to process speech signals sampled at a sampling rate of 16 kHz and at a resolution of sixteen bits per sample. This information is pre-stored in the decoding control unit 105. If the decoding control unit 105 determines that the received speech data does not conform to this sampling rate and/or resolution, then it outputs a control signal to a switch 113 so that the decoded speech data (or the unencoded speech data) is passed to a resampler 115 which resamples and/or requantises the speech data as appropriate. The speech data at the required sampling rate and resolution is then output from the speech decoding unit 103 to the ASR engine 111 shown in FIG. 6, which uses, in this embodiment, a dynamic programming comparison technique to compare the received speech with stored reference models generated in advance during a training session from known speech signals. FIG. 8 is a block diagram showing in more detail the main components of the ASR engine 111 used in this embodiment. As shown, the ASR engine 111 includes a frame generator 112 which receives the speech samples output from the speech decoding unit 103 and groups them into blocks or frames of speech samples each representing, in this embodiment, 20 ms of speech. Each frame thus generated is then passed to a frame processor 114 which processes the speech samples in a frame to generate a set of parameters representative of the speech within the frame. In this embodiment, the frame processor 114 performs a cepstral analysis of the speech samples within each frame. The sequence of frames output by the frame processor 114 are then passed to a dynamic programming (DP) matching unit 116 which compares the received sequence of parameter frames with reference models from the word model set store 121 (shown in FIG. 6).

FIG. 9 illustrates the dynamic programming matching operation performed by the DP matching unit 116 in comparing the received sequence of parameter frames (labelled f₀ to f₇) with one of the reference word models which, in the illustration has eight parameter frames s₀ to s₇. As shown in FIG. 9, during this matching process, the DP matching unit 116 propagates a plurality of dynamic programming paths (represented by the lines 131-1 to 131-3), each path representing a possible matching between a sequence of the received parameter frames and a sequence of the reference model parameter frames. As the DP matching unit 116 receives each new parameter frame, it propagates each of the dynamic programming paths using predetermined dynamic programming constraints. For example, considering the dynamic programming path 131-3, the constraints may specify that the dynamic programming path 131-3 may propagate to point A, B or C. To propagate the point to path A, the DP matching unit 116 compares the received parameter frame f₇ with the reference model parameter frame s₁ and modifies the score for path 131-3 according to the similarity between these two parameter frames. Similarly, to propagate the path 131-3 to point B, the DP matching unit 116 compares the received input frame f₇ with parameter frame s₂ of the reference model and then modifies the score for the path 131-3 according to how similar the two parameter frames are. A similar operation is performed to propagate the path to point C. The DP matching unit 116 performs a similar matching operation of the received speech against each of the reference word models known to the system. The scores generated by the DP matching unit 116 are then passed to a score comparison unit 118 which determines the reference word which is most similar to the received speech and outputs this as the recognised speech.

Returning to FIG. 6, in this embodiment, two sets of reference word models are stored in the word model set store 121 of the remote server 5. The first set of reference word models is generated during a training session from known speech signals which have been encoded by the encoder 53 and decoded by the decoder 109 and the second set of reference word models is generated during a training session from known speech which is not encoded and decoded. In this embodiment, the first set of reference word models is used by the DP matching unit 116 when the received speech was transmitted in an encoded format and the second set is used by the DP matching unit 116 when the received speech was transmitted in an unencoded format.

In this embodiment, the control of which set of reference word models the DP matching unit 116 uses during the recognition process is controlled by a parameter control unit 123. As shown in FIG. 7, the parameter control unit 123 determines whether or not the received speech was encoded from the encoding control data 85 which it receives from the speech decoding unit 103. In this embodiment, the parameter control unit 123 switches the set of reference word models used by the DP matching unit 116 each time the encoding control data 85 changes. In practice, this means that during the dynamic programming (DP) matching operation, the reference models against which the received speech is being compared, may change several times.

In particular, the parameter control unit 123 may determine that the set of reference word models being used by the DP matching unit 116 should be changed in the middle of the word being spoken. This is illustrated in FIG. 9. In particular, in FIG. 9, the first three parameter frames (f₀ to f₂) of the received speech were transmitted as unencoded speech data through the data network 11 and therefore, those parameter frames are compared with the parameter frames of the word models associated with the unencoded speech. In contrast, frames f₃ to f₇ of the received speech were transmitted as encoded speech and therefore, these frames are compared with parameter frames of the word models associated with the encoded speech.

As shown in FIG. 6, the recognition result output from the ASR engine 111 is passed to a voicemail control unit 125 which receives the recognised voice command and which controls the retrieval and/or deletion of the required message from the voicemail data store 3. If a message is to be replayed back to the user, then the voicemail control unit 125 passes the message to the network interface unit 101 instructing it to packetise the message and to transmit it back to the appropriate client terminal 9.

The inventors have established that by changing the reference word models used during the recognition process in accordance with how the received speech was transmitted through the data network 11, a higher recognition accuracy can be achieved from the ASR engine 111.

In the first embodiment described above, the client terminal 9 monitored the traffic state within the data network 11 to determine whether or not to encode a received speech command for transmission through the data network 11. As those skilled in the art will appreciate, the client terminal 9 may be arranged to vary other parameters of the transmitted speech signal in addition to or instead of determining whether or not to encode the input speech.

SECOND EMBODIMENT

FIG. 10 is a block diagram showing in more detail the main components of a speech processing unit 39 used in the client terminal 9 of a second embodiment. As shown in FIG. 10, in this embodiment, the speech control unit 55 varies the quantisation that is performed by the quantiser 51 in dependence upon the traffic state of the data network 11. In particular, in the first embodiment, the quantiser 51 was arranged to quantise each of the speech samples into a 16-bit binary value. In this embodiment, the speech control unit 55 is operable to vary the number of bits that are used to represent each speech sample such that when the data network 11 is busy, the quantiser 51 uses 8 bits to represent each speech sample and when the data network 11 is not busy, then the quantiser 51 uses 16 bits to represent each speech sample. In this way, the amount of data required to represent the input speech signal can be varied in dependence upon the current traffic state of the data network 11 through which the speech data has to be transmitted. In this embodiment, the sampler 49 is arranged to sample the received speech signal at 16 kHz and the encoder 53 is arranged to perform a conventional loss-less encoding technique.

In this embodiment, in the server terminal 5, the speech decoding unit 105 uses the resolution control data 87 to determine the resolution of the received speech data 83 and then controls the position of switch 113 so that it is reconverted, if necessary, into the appropriate resolution for the ASR engine 111. Further, in this embodiment, instead of passing the encoding control data 85 to the parameter control unit 123, in this embodiment, the speech decoding unit 105 passes the resolution control data 87 to the parameter control unit 123, which uses this control data to select the appropriate set of word models from the word model set store 121 to be used by the ASR engine 111. In this embodiment, there are two sets of word models stored within the word model store 121. The first set was generated during a training session from speech data quantised to an 8-bit resolution and which is subsequently converted to a 16-bit resolution. The second set of word models was generated from known speech signals initially quantised at a 16-bit resolution.

### THIRD EMBODIMENT

FIG. 11 shows a block diagram illustrating the main components of the speech processing unit 39 used in the client terminal 9 of a third embodiment. In this embodiment, the speech control unit 55 varies the rate at which the sampler 49 samples the received speech signal. In particular, in this embodiment, the speech control unit 55 changes the sampling rate between 8 kHz and 16 kHz, depending on the current traffic state of the data network 11. In particular, if the network if busy, then the lower sampling rate of 8 kHz is used whereas if the data network 11 is not busy, then the higher sampling rate of 16 kHz is used. In this embodiment, a constant quantisation is performed by the quantiser 51 and a conventional loss-less encoding technique is carried out by the encoder 53.

In the remote server 5, the decoding control unit 105 uses the sampling rate control data 89 to determine whether or not a resampling of the received speech data 83 needs to be performed by the resampler 115 before being passed to the ASR engine 111. Further, in this embodiment, instead of passing the encoding control data 85 to the parameter control unit 123, in this embodiment, the decoding unit 105 passes the sampling rate control data 89 to the parameter control unit 123. The parameter control unit 123 then uses this sampling rate control data 89 to control which set of word models are to be used by the ASR engine 111. In this embodiment, two sets of word models are stored in the word model set store 121, one generated from training speech data sampled at a sampling rate of 8 kHz and then resampled to 16 kHz and the other generated from training speech data initially sampled at 16 kHz.

### FOURTH EMBODIMENT

FIG. 12 is a block diagram showing in more detail the main components of the speech processing unit 39 used in the client terminal 9 of a fourth embodiment. As shown, in this embodiment, the speech control unit 55 uses the traffic status information received from the network traffic monitor 37 to vary: (i) the rate at which the sampler 49 samples the received speech signal; (ii) the quantisation performed by the quantiser 51; and (iii) the encoding performed by the encoder 53.

In this embodiment, the sampler 49 can vary the sampling rate to be either 8 kHz or 16 kHz. The quantiser 51 can vary the quantisation performed either between a “linear” quantisation such as that illustrated in FIG. 4 or a “non-linear” quantisation which allows smaller amplitude signals to be more finely quantised than larger amplitude signals. Such a non-linear quantisation is illustrated in FIG. 12. The use of such non-linear quantisation is well-known to those skilled in the art of speech encoding and will not be described further. In addition to being able to vary the quantisation between linear and non-linear, the quantiser 51 used in this embodiment can also vary the number of bits used to represent each speech sample (again 16 bits per sample or 8 bits per sample). Finally, the encoder 53 can either perform no encoding on the digitised speech samples, or it can perform a CELP-type encoding as in the first embodiment.

As those skilled in the art will appreciate from the above, it is therefore possible, in this embodiment, to generate 16 different representations of the received speech signal using the speech processing unit 39 shown in FIG. 12. As a result, it is possible to determine up to sixteen different levels of traffic within the data network 11 and to pick an appropriate combination of sample rate, quantisation and encoding for the current traffic state.

In the remote server 5 of this embodiment, the decoding control unit 105 uses the sampling rate control data 89, the resolution control data 87 and the encoding control data 85 to process the received speech data 83 into the appropriate format for the ASR engine 111. Further, in this embodiment, the sample rate control data 89, the resolution control data 87 and the encoding control data 85 are all passed to the parameter control unit 123 which then selects an appropriate set of word models from the word models set store 121. As discussed above, in this embodiment, there are sixteen different ways in which the user's speech command may be transmitted through the data network 11. In this embodiment, sixteen different sets of word models are stored within the word model store 121 each associated with one of the ways in which the user's speech command is transmitted through the data network 11. The parameter control unit 123 then uses the control data received from the speech decoding unit 103 to select the appropriate set of word models for use by the ASR engine 111. As in the other embodiments, the sixteen sets of word models are generated from known training speech which is initially processed in the same way that it would be processed by the speech processing unit 39 of the client terminal 9 and then converted into the format for the ASR engine 111 by the speech decoding unit 103.

### FIFTH EMBODIMENT

In the above embodiments, the speech decoding unit 103 outputs the appropriate control data to the parameter control unit 123 so that it could select the appropriate set of word models for use by the ASR engine 111. An embodiment will now be described in which the speech decoding unit 103 does not output the control parameters but in which the control parameters are estimated from the decoded and resampled speech data output by the speech decoding unit 103.

FIG. 14 illustrates the main components of the remote server 5 and the voicemail data store 3 used in this embodiment. As shown, the same reference numerals have been used to designate the same components and these will not be described again. The client terminal 9 used in this embodiment may be the one used in any of the preceding embodiments. As mentioned above, in this embodiment, the speech decoding unit 103 only outputs the decoded and, if appropriate, resampled speech data which it passes to the ASR engine 111. In this embodiment, the speech decoding unit 103 also passes this decoded speech data to a parameter estimator 131 which compares the received decoded speech data with speech models stored in a speech model 133, in order to estimate what the encoding control data 85, resolution control data 87 and/or the sampling rate control data 89 would be. This is possible, because the speech data output by the speech decoding unit 103 will include artefacts dependent on what processing was performed by the speech decoding unit 103. The parameter estimator 131 then compares the decoded speech data with speech models that model these artefacts, in order to determine what processing was performed in the speech decoding unit 103 and hence what processing was performed in the client terminal 9. In this embodiment, the parameter estimator 131 uses a dynamic programming matching technique to compare the decoded speech with the speech models, although other comparison techniques could be used.

In this embodiment, a separate speech model is stored within the model store 133 for each possible way in which the user's speech may be transmitted over the data network 11 (and therefore for each possible combination of control data values). Each of these models is generated during a training routine in which known but different speech utterances are transmitted in the corresponding way through the data network 11 and then processed by the speech decoding unit 103 to regenerate corresponding speech samples for use by the ASR engine 111. The processed speech samples are then modelled using a speech model (e.g. template, HMM etc.) which models the form of the training speech as opposed to the content of the training speech. In generating a speech model for each of the possible ways in which the user's speech may be transmitted over the data network 11, the system processes the training speech for that model (for example to generate sequences of feature vectors) which it then averages across the training speech in order to generate a model which is representative of all of the training speech. In this way, the differences between the sequences of feature vectors caused by the different content within each training utterance will be averaged out, thereby highlighting any features which the training speech have in common such as the artefacts discussed above. The speech models thus generated are then stored in the speech model store 133. Subsequently, during use, the parameter estimator 131 compares the decoded speech data with the speech models to determine which model the decoded speech is most similar to. The appropriate control data associated with that model is then output to the parameter control unit 123 which selects the appropriate set of word models to be used by the ASR engine 111 as before.

Modifications

A number of embodiments have been described above in which the word models used by an automatic speech recognition system for recognising speech data transmitted over a data network are changed in dependence upon the way in which the received speech signal is processed for transmission through the network. As those skilled in the art will appreciate, various modifications can be made to the embodiments described above and some of these modifications will now be described.

In the fourth embodiment described above, the speech signal input by the user to the client terminal 9 could be processed in sixteen different ways depending on the current traffic state in the data network 11. Further, in the remote server 5, sixteen different sets of word models were stored and the appropriate one to be compared with the received speech was dynamically chosen based on how the speech was processed in the client terminal 9. As those skilled in the art will appreciate, it is not essential to have a separate set of word models for each of the possible different ways of processing the speech signal. For example, some of the sets of word models may be very similar to each other such that using a common set of word models for some of the different ways of processing the speech would not significantly alter the recognition accuracy of the ASR engine 111. In such an embodiment, the parameter control unit 123 might relate the received parameter control data to the appropriate set of word models through a look-up table which identifies the set of word models to be used for all the different possible values of the parameter control data.

In the above embodiments, different sets of word models were stored in the word model sets store. In an alternative embodiment, the different sets of word models may be automatically generated when they are needed from a single set of stored word models. This may be done by passing the stored set of word models through an appropriate processing module which would perform the appropriate adaptation of the stored set of word models to generate the currently required set of word models. The processing unit may perform a linear type transformation or a non-linear type transformation using, for example, an appropriate neural network. The transformation function or the neural network parameters may be determined in advance from training data relating the input set of word models to the desired set of word models. Alternatively, the single set of stored word models may be stored together with adaptation data which describes how the word models should be adapted to obtain the different sets of word models that will be required.

In the above embodiments, the speech processing unit monitored the traffic state of a data network and controlled one or more of the sampling rate, resolution and encoding technique used to encode a received speech signal. As those skilled in the art will appreciate, it is possible to vary other parameters of the speech processing carried out instead of or in addition to those varied in the above embodiments. For example, different analogue to digital converters may be employed depending on the current traffic within the data network.

In the above embodiments, the speech processing unit varied the sampling rate, the resolution and the encoding between two different possibilities. As those skilled in the art will appreciate, various different sampling rates, resolutions and encoding techniques may be employed, with an appropriate sampling rate, resolution and/or encoding technique being chosen depending on the current network traffic state. For example, the speech processing unit may be able to choose between three different sampling rates, five different quantisation levels and/or four different encoding techniques. Examples of other encoding techniques which may be used are run length encoding, LPC encoding etc. Alternatively, the speech processing unit may vary the number of LPC or CELP parameters used to represent each frame of input speech, depending on the traffic state within the data network.

In embodiments where the speech processing unit may vary two or more parameters of the digitisation process, it is not essential for the remote server to have a different set of word models for each possible digitisation process which can be performed by the speech processing unit. For example, in an embodiment where the sampling rate and the encoding technique used may be varied, the remote server may only store different sets of word models depending on the different encoding techniques used. In such an embodiment, the speech decoding unit forming part of the remote server would only pass the encoding control data to the parameter control unit and would not pass the sampling rate control data. Further, in such an embodiment, the word models used would preferably be generated from training speech data sampled at the different possible sampling rates and then converted into the appropriate sampling rate for the ASR engine, so that the models are robust to the varying sample rates being transmitted. The automatic speech recognition engine would also have to use a different frame processor to process the digitised speech data at the different sample rates. The appropriate frame processor to be used for the digitised speech data currently being received would then be selected based on the sampling rate control data.

In the above embodiments, the speech processing unit in the client terminal digitised the received analogue speech signal directly. As those skilled in the art will appreciate, this is not essential. The speech processing unit may receive an already digitised version of the input speech signal which it can then re-sample and re-quantise and encode depending on the monitored traffic state within the data network. Such an embodiment is likely to occur in practical systems where the input speech is digitised through a sound card and the speech processing unit forms part of a software module running on the client terminal.

In the above embodiments, the client terminal varied the sampling rate, resolution or encoding technique of the speech in dependence upon the monitored traffic state within the network. In an alternative embodiment, the client terminal may output a constant representation of the speech signal to the data network and where the data network includes a processing node which receives the speech data from the client terminal and which varies the sampling rate, resolution or encoding of the received speech data based on the data path to be taken from the processing node to arrive at the server terminal.

In the first embodiment, the speech processing unit used a sampling rate and a resolution that was matched to that required by the automatic speech recognition engine. As those skilled in the art will appreciate, if all client terminals are arranged to transmit the speech data at the same sampling rate and resolution required by the ASR engine then it is not essential to transmit the sampling rate control data and the resolution control data to the remote server. In this case, the speech decoding unit would only use the encoding control data in the manner described above.

In the above embodiment, the speech decoding unit changed the sampling rate and the resolution of the received speech data so that it matched that required by the ASR engine. As those skilled in the art will appreciate, this is not essential. In an alternative embodiment, the speech decoding unit may only perform, for example, the inverse encoding performed by the speech processing unit. Further, if variable sampling rates and resolutions are possible, then the speech decoding unit may output the received speech data at the received sampling rate and resolution and inform the ASR engine what the sampling rate and resolution are for the received speech. In such an embodiment, the ASR engine 111 would vary the number of samples in each frame depending on the received sampling rate. The ASR engine would also requantise the samples so that the required number of bits per sample were provided.

In the embodiments described above in which the speech processing unit varied the encoding technique performed in dependence upon the monitored traffic state of the data network, different sets of word models were stored for the different encoding techniques used. This is not essential. For example, an embodiment may be provided in which the speech processing unit varies both the sampling rate and the encoding technique performed but the remote terminal only stores different sets of word models for the different sampling rates. In this case, it is also not essential for the decoding unit to decode the received speech data. Instead, the decoding unit may pass the received speech data to the ASR engine together with data identifying whether or not the speech data is encoded and if so according to what technique. In such an embodiment, the ASR engine would have to perform a different processing on the received speech data depending on how it was encoded. For example, if it was encoded using CELP parameters and the word models are stored as cepstral parameters, then the ASR engine will require an appropriate processing unit to convert the CELP parameters into cepstral parameters, which can then be matched with the stored reference models. The way in which such conversions may be achieved are well known to those skilled in the art and will not be described here.

In the above embodiments, the client terminal either transmitted the parameter data to the remote server or the remote server determined the parameter data from the processed digitised speech data. As those skilled in the art will appreciate, the server terminal may determine the parameter data itself, for example, by monitoring the traffic state within the data network and using this to predict what the parameter control data will be based on knowledge of how the control terminal will vary the digitisation process based on the monitored traffic state.

In the above embodiments, the speech processing unit effectively varied the digitisation process performed to generate a digital representation of the received analogue speech signal depending on the current traffic state within the data network. As those skilled in the art will appreciate, the speech processing unit may vary this digitisation process in dependence upon other factors in addition to or instead of the traffic state of the network. For example, the speech processing unit may vary the digitisation process in dependence upon the time of day.

In the above embodiments, different sets of word models were stored and an appropriate set of word models was chosen based on how the user's input speech was digitised and encoded within the user's terminal and then decoded in the remote server. As those skilled in the art will appreciate, it is not essential to use word models. Other sub-word unit models such as phoneme models may be used. In this case, rather than using template models, Hidden Markov Models or other statistical models may be used. The operation of such an embodiment would be identical to that described above and will not, therefore, be described in further detail.

In the above embodiments, the different word models from all of the sets of word models representing the same word have the same topology (i.e. the same number of frames or the same number of HMM states). As those skilled in the art will appreciate, using models having the same topology facilitates the swapping of the models during the recognition process. However, it is not essential. Different topology models may be used in the different sets of models, with an appropriate mapping function being used to identify how the frames or states of one model map to those of another model.

In the fifth embodiment described above, the parameter estimator compared the decoded speech with stored speech models. Before comparing the decoded speech with the speech models, the parameter estimator may have to process the decoded speech data so that it is in a format suitable for comparing with the models. For example, the parameter estimator may have to perform a similar cepstral analysis of the speech data as performed by the ASR engine. Alternatively, the parameter estimator may estimate the parameters directly from the decoded speech samples based on heuristic models which try to define the above-mentioned artefacts in the decoded speech. For example, if the client terminal samples the speech signal at a sampling rate of 8 kHz and the decoder resamples this to 16 kHz and simply duplicates each speech sample, then the parameter estimator can simply compare adjacent speech samples in the decoded speech to determine if the received speech data has been resampled. Similar heuristic rules may be used to identify whether or not the speech data has been requantised etc. Further, as those skilled in the art will appreciate the parameter estimator may use a combination of heuristic rules and speech models to estimate the values of the parameters which are passed to the parameter control unit.

In the above embodiments, the client terminal was a personal computer. As those skilled in the art will appreciate, other types of client terminal may be used. For example, a personal digital assistant, web browser or a mobile phone may be used as a client terminal.

The above embodiments have described a mail retrieval system which allows users to retrieve voice mails and leave voice mails for other users using input speech commands. As those skilled in the art will appreciate, the above techniques for dealing with speech commands and transmitting them over a data network may be provided in other systems. For example, the system may form part of a web site in which the user can select various goods and services or other web pages or interact with a character on the web site using voice commands.

In the above embodiments, the user's speech command was transmitted over an IP data network. As those skilled in the art will appreciate, this is not essential. The data may be transmitted over any data network.

1. A speech processing system comprising:
a data network;
a processing terminal coupled to said data network and comprising:
a first receiver operable to receive an input speech signal;
a digitiser operable to digitise the received input speech signal to generate digitised speech data representative of the input speech signal;
a first varying device operable to dynamically vary a digitising parameter of said digitiser in dependence upon an external condition to generate digitised speech data that varies with the variation of said digitising parameter; and
a transmitter operable to transmit the digitised speech data over the data network; and
a server terminal coupled to said data network and comprising:
a second receiver operable to receive the digitised speech data from the data network;
a processor operable to process the received digitised speech data to generate processed digitised speech data that is independent of the variation of said digitising parameter that is varied by said first varying device;
a speech recogniser operable to compare the processed digitised speech data with a set of speech recognition models to generate a recognition result;
a third receiver operable to receive parameter data identifying the dynamic variation of said digitising parameter performed by said first varying device; and
a second varying device operable to dynamically vary the set of speech recognition models used by said speech recogniser in dependence upon the received parameter data.

2. A system according to claim 1, wherein said first varying device is operable to dynamically vary a plurality of digitising parameters of said digitiser in dependence upon said external condition.

3. A system according to claim 2, wherein said processor is operable to process the received digitised speech data to generate processed digitised speech data that is independent of the variation of at least one of the digitising parameters that are varied by said first varying device.

4. A system according to claim 3, wherein said third receiver is operable to receive parameter data identifying the dynamic variation of said at least one of said digitising parameters performed by said first varying device.

5. A system according to claim 3, wherein said processor is operable to process the received digitised speech data to generate processed digitised speech data that is independent of the variation of all of said digitising parameters that are varied by said first varying device.

6. A system according to claim 1, wherein said digitiser is operable to sample the received input speech signal and to quantise each sample to generate said digitised speech data.

7. A system according to claim 6, wherein said first varying device is operable to dynamically vary the rate at which said digitiser samples said input speech signal in dependence upon said external condition.

8. A system according to claim 6, wherein said first varying device is operable to dynamically vary the quantisation performed by said digitiser in dependence upon said external condition.

9. A system according to claim 6, wherein said digitiser comprises an encoder which is operable to encode the quantised speech samples to generate said digitised speech data.

10. A system according to claim 9, wherein said first varying device is operable to dynamically vary the encoding performed by said encoder in dependence upon said external condition.

11. A system according to claim 10, wherein said first varying device is operable to vary whether or not said encoder encodes the quantised speech data in dependence upon said external condition.

12. A system according to claim 10, wherein said first varying device is operable to select a lossless encoding technique or a non-lossless encoding technique to be performed by said encoder in dependence upon said external condition.

13. A system according to claim 1, further comprising a traffic monitor operable to monitor a traffic state within said data network and wherein said first varying device is operable to dynamically vary said digitising parameter of said digitiser in dependence upon the monitored traffic state within said data network.

14. A system according to claim 1, wherein said transmitter is operable to transmit parameter data to said data network, which parameter data identifies the dynamic variation of said digitising parameter performed by said first varying device.

15. A system according to claim 1, wherein said processing terminal further comprises a data packet generator operable to generate data packets using said digitised speech data and wherein said transmitter is operable to transmit said data packets to said data network.

16. A system according to claim 15, wherein each data packet includes parameter data identifying the processing performed by said digitiser to generate the digitised speech data within said data packet.

17. A system according to claim 16, wherein said processor of said server terminal is operable to extract said parameter data from each data packet and to process said received digitised speech data in dependence upon the parameter data within the data packet to generate said processed digitised speech data.

18. A system according to claim 17, wherein said processor of said server terminal is operable to output said parameter data extracted from said data packet to said third receiver.

19. A system according to claim 1, wherein said processor of said server terminal is operable to process said received digitised speech data to generate processed digitised speech data that is in a predetermined format suitable for use by said speech recogniser.

20. A system according to claim 1, wherein said server terminal comprises a data store for storing a plurality of sets of speech recognition models and wherein said second varying device is operable to dynamically vary the set of speech recognition models used by said speech recogniser by selecting a set of speech recognition models in dependence upon the received parameter data.

21. A system according to claim 20, wherein said second varying device comprises a lookup table relating parameter data to a set of speech recognition models to be used by said speech recogniser.

22. A system according to claim 1, wherein said server terminal includes a data store for storing a common set of speech recognition models and wherein said second varying device is operable to dynamically vary the common set of speech recognition models in dependence upon the received parameter data.

23. A system according to claim 22, wherein said second varying device comprises a neural network which is operable to vary the common set of speech recognition models in dependence upon the received parameter data.

24. A system according to claim 1, wherein said server terminal further comprises: a speech model store operable to store one or more speech models each associated with respective parameter data identifying a different variation of said digitising parameter or parameters which can be performed by said first varying device; and
a comparator operable to compare said processed digitised speech data with said speech models to generate parameter data identifying the dynamic variation of said digitising parameter performed by said first varying device, and operable to output the generated parameter data to said third receiver.

25. A system according to claim 1, wherein said processing terminal comprises a sensor operable to sense said external condition, a comparator operable to compare the sensed external condition with a predetermined threshold value and wherein said first varying device is operable to change said digitising parameter in dependence upon a comparison result output by said comparator.

26. A system according to claim 1, wherein said first receiver of said processing terminal is operable to receive first digitised speech data as said input speech signal; and wherein said digitiser is operable to generate second digitised speech data representative of the input speech signal from the first digitised speech data.

27. A system according to claim 26, wherein said processing terminal forms part of said data network and said first receiver receives said first digitised speech data from a client terminal.

28. A system according to claim 1, wherein said processing terminal forms part of a client terminal coupled to said data network.

29. A server terminal couplable to a data network and comprising:
a first receiver operable to receive digitised speech data representative of an input speech signal, which digitised speech data varies in dependence upon the variation of a digitising parameter used to generate the digitised speech data;
a processor operable to process the received digitised speech data to generate processed digitised speech data that is independent of the variation of said digitising parameter;
a speech recogniser operable to compare the processed digitised speech data with a set of speech recognition models to generate a recognition result;
a second receiver operable to receive parameter data identifying the dynamic variation of said digitising parameter; and
a varying device operable to dynamically vary the set of speech recognition models used by said speech recogniser in dependence upon the received parameter data.

30. A server terminal according to claim 29, wherein said digitised speech data varies in dependence upon a plurality of digitising parameters used to generate the digitised speech data and wherein said processor is operable to process the received digitised speech data to generate processed digitised speech data that is independent of the variation of at least one of the digitising parameters that are varied.

31. A server terminal according to claim 30, wherein said second receiver is operable to receive parameter data identifying the dynamic variation of said at least one of said digitising parameters.

32. A server terminal according to claim 30, wherein said processor is operable to process the received digitised speech data to generate processed digitised speech data that is independent of the variation of all of said digitising parameters that are varied.

33. A server terminal according to claim 29, wherein said first receiver is operable to receive data packets including parts of said digitised speech data.

34. A server terminal according to claim 33, wherein each data packet includes parameter data identifying the processing performed to generate the digitised speech data within said data packet.

35. A server terminal according to claim 34, wherein said processor is operable to extract said parameter data from each data packet and to process said received digitised speech data in dependence upon the parameter data within the data packet to generate said processed digitised speech data.

36. A server terminal according to claim 35, wherein said processor is operable to output said parameter data extracted from said data packet to said third receiver.

37. A server terminal according to claim 29, wherein said processor is operable to process said received digitised speech data to generate processed digitised speech data that is in a predetermined format suitable for use by said speech recogniser.

38. A server terminal according to claim 29, comprising a data store for storing a plurality of sets of speech recognition models and wherein said varying device is operable to dynamically vary the set of speech recognition models used by said speech recogniser by selecting a set of speech recognition models in dependence upon the received parameter data.

39. A server terminal according to claim 38, wherein said varying device comprises a lookup table relating parameter data to a set of speech recognition models to be used by said speech recogniser.

40. A server terminal according to claim 27, further comprising a data store for storing a common set of speech recognition models and wherein said varying device is operable to dynamically vary the common set of speech recognition models in dependence upon the received parameter data.

41. A server terminal according to claim 40, wherein said varying device comprises a neural network which is operable to vary the common set of speech recognition models in dependence upon the received parameter data.

42. A server terminal according to claim 29, further comprising: a store operable to store one or more speech models each associated with respective parameter data identifying a different variation of said digitising parameter or parameters; and
a comparator operable to compare said processed digitised speech data with said speech models to generate parameter data identifying the dynamic variation of said digitising parameter, and operable to output the generated parameter data to said second receiver.

43. A speech processing method using a processing terminal, a data network and a server terminal, the method comprising:
at the processing terminal:
receiving an input speech signal;
digitising the received input speech signal to generate digitised speech data representative of the input speech signal;
a first varying step of dynamically varying a digitising parameter of said digitising step in dependence upon an external condition to generate digitised speech data that varies with the variation of said digitising parameter; and
transmitting the digitised speech data over the data network; and
at the server terminal:
receiving the digitised speech data from the data network;
processing the received digitised speech data to generate processed digitised speech data that is independent of the variation of said digitising parameter that is varied in said varying step;
comparing the processed digitised speech data with a set of speech recognition models to generate a recognition result;
receiving parameter data identifying the dynamic variation of said digitising parameter performed in said first varying step; and
a second varying step of dynamically varying the set of speech recognition models used in said comparing step in dependence upon the received parameter data.

44. A method according to claim 43, wherein said first varying step dynamically varies a plurality of digitising parameters of said digitising step in dependence upon said external condition.

45. A method according to claim 44, wherein said processing step processes the received digitised speech data to generate processed digitised speech data that is independent of the variation of at least one of the digitising parameters that are varied in said first varying step.

46. A method according to claim 45, wherein said step of receiving parameter data receives parameter data identifying the dynamic variation of said at least one of said digitising parameters performed in said first varying step.

47. A method according to claim 45, wherein said processing step processes the received digitised speech data to generate processed digitised speech data that is independent of the variation of all of said digitising parameters that are varied in said first varying step.

48. A method according to claim 43, wherein said digitising step samples the received input speech signal and quantises each sample to generate said digitised speech data.

49. A method according to claim 48, wherein said first varying step dynamically varies the rate at which said digitising step samples said input speech signal in dependence upon said external condition.

50. A method according to claim 48, wherein said first varying step dynamically varies the quantisation performed in said digitising step in dependence upon said external condition.

51. A method according to claim 48, wherein said digitising step comprises the step of encoding the quantised speech samples to generate said digitised speech data.

52. A method according to claim 51, wherein said first varying step dynamically varies the encoding performed in said encoding step in dependence upon said external condition.

53. A method according to claim 52, wherein said first varying step varies whether or not said encoding step encodes the quantised speech data in dependence upon said external condition.

54. A method according to claim 52, wherein said varying step selects a lossless encoding technique or a non-lossless encoding technique to be performed in said encoding step in dependence upon said external condition.

55. A method according to claim 43, further comprising the step of monitoring a traffic state within said data network and wherein said first varying step dynamically varies said digitising parameter of said digitising step in dependence upon the monitored traffic state within said data network.

56. A method according to claim 43, wherein said transmitting step transmits parameter data to said data network, which parameter data identifies the dynamic variation of said digitising parameter performed in said first varying step.

57. A method according to claim 43, wherein said processing terminal further comprises the step of generating data packets using said digitised speech data and wherein said transmitting step transmits said data packets to said data network.

58. A method according to claim 57, wherein each data packet includes parameter data identifying the processing performed in said digitising step to generate the digitised speech data within said data packet.

59. A method according to claim 58, wherein said processing step of said server terminal extracts said parameter data from each data packet and processes said received digitised speech data in dependence upon the parameter data within the data packet to generate said processed digitised speech data.

60. A method according to claim 59, wherein said processing step of said server terminal outputs said parameter data extracted from said data packet to said parameter data receiving step.

61. A method according to claim 43, wherein said processing step of said server terminal processes said received digitised speech data to generate processed digitised speech data that is in a predetermined format suitable for use in said comparing step.

62. A method according to claim 43, wherein said server terminal comprises a data store for storing a plurality of sets of speech recognition models and wherein said second varying step dynamically varies the set of speech recognition models used in said comparing step by selecting a set of speech recognition models in dependence upon the received parameter data.

63. A method according to claim 62, wherein said selecting step uses a lookup table relating parameter data to a set of speech recognition models to be used in said comparing step.

64. A method according to claim 43, wherein said server terminal includes a data store for storing a common set of speech recognition models and wherein said second varying step dynamically varies the common set of speech recognition models in dependence upon the received parameter data.

65. A method according to claim 64, wherein said second varying step uses a neural network to vary the common set of speech recognition models in dependence upon the received parameter data.

66. A method according to claim 43, wherein said server terminal further comprises the steps of: storing one or more speech models each associated with respective parameter data identifying a different variation of said digitising parameter or parameters which can be performed in said first varying step; and
comparing said processed digitised speech data with said speech models to generate parameter data identifying the dynamic variation of said digitising parameter performed in said first varying step, and outputting the generated parameter data to said parameter data receiving step.

67. A method according to claim 43, further comprising the steps of, at said processing terminal, sensing said external condition, comparing the sensed external condition with a predetermined threshold value and wherein said first varying step changes said digitising parameter in dependence upon a comparison result output in said comparing step.

68. A method according to claim 43, wherein said receiving step of said processing terminal receives first digitised speech data as said input speech signal; and wherein said digitising step generates second digitised speech data representative of the input speech signal from the first digitised speech data.

69. A method according to claim 43, wherein said processing terminal forms part of said data network and said receiving step of said processing terminal receives said first digitised speech data from a client terminal.

70. A method according to claim 43, wherein said processing terminal forms part of a client terminal coupled to said data network.

71. A speech processing method comprising:
receiving digitised speech data representative of an input speech signal, which digitised speech data varies in dependence upon the variation of a digitising parameter used to generate the digitised speech data;
processing the received digitised speech data to generate processed digitised speech data that is independent of the variation of said digitising parameter;
comparing the processed digitised speech data with a set of speech recognition models to generate a recognition result;
receiving parameter data identifying the dynamic variation of said digitising parameter; and
dynamically varying the set of speech recognition models used in said comparing step in dependence upon the received parameter data.

72. A method according to claim 71, wherein said digitised speech data varies in dependence upon a plurality of digitising parameters used to generate the digitised speech data and wherein said processing step processes the received digitised speech data to generate processed digitised speech data that is independent of the variation of at least one of the digitising parameters that are varied.

73. A method according to claim 72, wherein said step of receiving parameter data receives parameter data identifying the dynamic variation of said at least one of said digitising parameters.

74. A method according to claim 72, wherein said processing step processes the received digitised speech data to generate processed digitised speech data that is independent of the variation of all of said digitising parameters that are varied.

75. A method according to claim 71, wherein said receiving step receives data packets including parts of said digitised speech data.

76. A method according to claim 75, wherein each data packet includes parameter data identifying the processing performed to generate the digitised speech data within said data packet.

77. A method according to claim 76, wherein said processing step extracts said parameter data from each data packet and processes said received digitised speech data in dependence upon the parameter data within the data packet to generate said processed digitised speech data.

78. A method according to claim 77, wherein said processing step outputs said parameter data extracted from said data packet to said parameter data receiving step.

79. A method according to claim 71, wherein said processing step processes said received digitised speech data to generate processed digitised speech data that is in a predetermined format suitable for use in said speech recognition step.

80. A method according to claim 71, further comprising the step of storing a plurality of sets of speech recognition models and wherein said varying step dynamically varies the set of speech recognition models used in said comparing step by selecting a set of stored speech recognition models in dependence upon the received parameter data.

81. A method according to claim 80, wherein said selecting step uses a lookup table relating parameter data to a set of speech recognition models to be used in said comparing step.

82. A method according to claim 71, further comprising the step of storing a common set of speech recognition models and wherein said varying step dynamically varies the common set of speech recognition models in dependence upon the received parameter data.

83. A method according to claim 82, wherein said varying step uses a neural network to vary the common set of speech recognition models in dependence upon the received parameter data.

84. A method according to claim 71, wherein said server terminal further comprises the steps of: storing one or more speech models each associated with respective parameter data identifying a different variation of said digitising parameter or parameters; and
comparing said processed digitised speech data with said speech models to generate parameter data identifying the dynamic variation of said digitising parameter, and outputting the generated parameter data to said parameter data receiving step.

85. A speech recognition apparatus comprising:
means for receiving digitised speech data representative of an utterance to be recognised;
means for storing speech recognition models;
means for comparing the received digitised speech data with the speech recognition models; and
means for generating a recognition result in dependence upon the comparisons made by said comparing means;
characterised by means for dynamically varying the speech recognition models during the comparison with said digitised speech data.

86. A speech processing system comprising:
a data network;
a processing terminal coupled to said data network and comprising:
means for receiving an input speech signal;
digitising means operable for digitising the received input speech signal to generate digitised speech data representative of the input speech signal;
first varying means for dynamically varying a digitising parameter of said digitising means in dependence upon an external condition to generate digitised speech data that varies with the variation of said digitising parameter; and
means for transmitting the digitised speech data over the data network; and
a server terminal coupled to said data network and comprising:
means for receiving operable to receive the digitised speech data from the data network;
means for processing the received digitised speech data to generate processed digitised speech data that is independent of the variation of said digitising parameter that is varied by said first varying means;
speech recognition means operable to compare the processed digitised speech data with a set of speech recognition models to generate a recognition result;
means for receiving parameter data identifying the dynamic variation of said digitising parameter performed by said first varying means; and
second varying means for dynamically varying the set of speech recognition models used by said speech recognition means in dependence upon the received parameter data.

87. A server terminal couplable to a data network and comprising:
means for receiving digitised speech data representative of an input speech signal, which digitised speech data varies in dependence upon the variation of a digitising parameter used to generate the digitised speech data;
means for processing the received digitised speech data to generate processed digitised speech data that is independent of the variation of said digitising parameter;
speech recognition means operable to compare the processed digitised speech data with a set of speech recognition models to generate a recognition result;
means for receiving parameter data identifying the dynamic variation of said digitising parameter; and
means for dynamically varying the set of speech recognition models used by said speech recognition means in dependence upon the received parameter data.

88. A computer readable medium storing computer executable instructions for causing a programmable computer device to perform the steps of:
receiving digitised speech data representative of an input speech signal, which digitised speech data varies in dependence upon the variation of a digitising parameter used to generate the digitised speech data;
processing the received digitised speech data to generate processed digitised speech data that is independent of the variation of said digitising parameter;
comparing the processed digitised speech data with a set of speech recognition models to generate a recognition result;
receiving parameter data identifying the dynamic variation of said digitising parameter; and
dynamically varying the set of speech recognition models used in said comparing step in dependence upon the received parameter data.

89. A computer readable medium storing computer executable instructions for causing a programmable computer apparatus to perform the method of claim 71.

90. A signal carrying processor executable instructions for causing a programmable computer apparatus to perform the method of claim 71.

91. A computer executable instructions product comprising computer executable instructions for causing a programmable computer device to carry out the method of claim 71.
